(19) United States
(12) Patent Application Publication
(10) Pub. No.: US 2010/0007469 A1
(43) Pub. Date: Jan. 14, 2010

(54) DYNAMICALLY TRIGGERABLE NANO RFID DEVICE AND RELATED METHOD

(76) Inventor: Mario W. CARDULLO, Alexandria, VA (US)

Correspondence Address: MCGUIREWOODS, LLP, 1750 TYSONS BLVD, SUITE 1800, MCLEAN, VA, 22102, US

(21) Appl. No.: 12/501,909

(22) Filed: Jul. 13, 2009

Related U.S. Application Data
(60) Provisional application No. 61/079,936, filed on Jul. 11, 2008.

(51) Int. Cl. H04Q 5/22

(52) U.S. Cl. 340/10.1

(57) ABSTRACT

A nano RFID device or tag and method for using same are disclosed. The nano RFID device may be less than about 150 nanometers in size. The nano RFID device may be a passive, active or semi-passive nano RFID device. The nano RFID device may be distributed to a target such as a human or animal or products, for example. The nano RFID device may include a nano antenna that may comprise one or more carbon tubes. The nano RFID device may include a nano battery. The nano RFID device may include an environmentally reactive layer that reacts to its immediate environment to affix or adhere to a target. The nano RFID device may be constructed for direct or indirect distribution techniques such as by airborne techniques for inhalation, consumption distribution for ingestion, or contact distribution, for example. The nano RFID device may also be constructed to deliver, on command or other certain conditions, an effect such as a virus, compound, toxin or the like, on a target such as a terrorist, for example.

### CROSS-REFERENCE TO RELATED APPLICATIONS

This application claims benefit and priority to U.S. Provisional No. 61/079,936, filed Jul. 11, 2008, entitled DYNAMICALLY TIGGERABLE NANO RFID DEVICE AND RELATED METHOD, the disclosure of which is incorporated by reference herein, in its entirety.

### BACKGROUND OF THE INVENTION

1. Field of the Invention

The invention is directed generally to a device and method related to nano radio frequency identification (RFID) technology and, more specifically, to a nano RFID device and method for dynamically distributing and triggering the nano RFID device to facilitate covert tracking and/or identification of a target subject, such as a person or an animal, including dynamically triggering the nano RFID device to impart an effect on a target subject, such as a terrorist, for example.

2. Related Art

Many systems and methods exist for tracking inanimate items such as packages or shipping containers using radio frequency identification (RFID) technology. However, there are few practical techniques for tracking people or animals in a dynamic manner. In particular, there are few, if any, techniques for covertly tracking a person or an animal with a capability to deliver an effect to the person or animal via an RFID technique, with a capacity to trigger the effect on the person or animal.

Most common RFID tags typically contain at least two parts. One is an integrated circuit for storing and processing information, modulating and demodulating a radio frequency (RF) signal, and other specialized functions. The second part is an antenna for receiving and transmitting a signal. A technology called chipless RFID allows for discrete identification of tags without an integrated circuit, thereby allowing tags to be printed directly onto assets at a lower cost than traditional tags.

Passive RFID tags typically have no internal power supply. The electrical current induced in the antenna by the incoming radio frequency signal provides just enough power for the CMOS integrated circuit in the tag to power up and transmit a response. Most passive tags signal by backscattering a carrier wave from a reader. This may mean that the antenna has to be designed both to collect power from the incoming signal and also to transmit the outbound backscatter signal. The response of a passive RFID tag is not necessarily just an ID number; the tag chip can contain non-volatile, perhaps writable, EEPROM for storing data.

Semi-passive tags are similar to active tags in that they have a power source, but it may only power the micro-circuitry and may not power the broadcasting of the signal. The response may be powered by the backscattering of the RF energy from the reader.

However, the current technology for all these types of tags, passive and active, still requires relatively “large” physical packaging. Because of the size constraints, applications requiring RFID technology may be unduly restrictive. Moreover, current tags do not impart any effect on their associated entities.

Accordingly, there is a need for a method and device for providing RFID technology with a smaller form factor enabling dynamic targeting or tracking of people, animals, and the like, with a capacity to deliver an effect.

### SUMMARY OF THE INVENTION

The invention meets the foregoing need and provides for a nano RFID device and related method suitable for use in applications requiring a tracking device of 200 nanometers or smaller in size. The nano RFID device constructed according to principles of the invention may be embedded in or distributed to a target, including humans, animals, compositions, fabrics, objects, or the like. In some applications, the nano RFID device as constructed according to principles of the invention may be distributed for inhalation or ingestion by a target. The nano RFID device when constructed according to the inventive principles herein may include an environmentally reactive layer to cause adhesion or attachment to a target. The nano RFID device may also include an effect component such as, for example, a toxin, a chemical compound, a virus, bacteria or the like, which may be releasable under certain conditions described herein.

Accordingly, in one aspect of the invention, a nano radio frequency identification (RFID) apparatus is provided that includes a radio frequency (RF) section configured to be responsive to an RF signal, an antenna operatively coupled to the RF section to receive the RF signal and to emit an identification response, and an effect component contained within the nano RFID apparatus configured to impart an effect, the effect component constructed to release the effect based upon receipt of a release signal, wherein the nano RFID device is configured to be less than about 150 nanometers in width, length and thickness.

In another aspect, a method for using a nano radio frequency identification (RFID) device, the nano RFID device includes a radio frequency (RF) section configured to be responsive to an RF signal, and an antenna operatively coupled to the RF section to receive the RF signal and to emit an identification response, and an effect component contained in the nano RFID device to release an effect based upon a release signal, wherein the nano RFID device is configured to be less than about 150 nanometers in width, length and thickness, the method includes the steps of storing identification data within the nano RFID device, distributing the nano device to a target for association with the target, and tracking the nano device by using the emitted identification response, and transmitting a signal to release the effect based on the identification response.

In another aspect, a method of delivering an effect on a target is provided that includes distributing a nano radio frequency identification (RFID) tag that has an effect component to a target and releasing the effect component at the target.

In yet another aspect, a nano radio frequency identification (RFID) apparatus is provided that includes an effect component contained within the nano RFID apparatus configured to impart an effect, the effect component constructed to release the effect based upon receipt of a release signal, wherein the nano RFID apparatus is configured to be less than about 200 nanometers in width, length and thickness.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 is a block diagram of an embodiment of a nano RFID device constructed according to principles of the invention, and a block diagram of an exemplary system configured according to principles of the invention, for controlling or tracking the nano RFID component;

FIG. 2 is a block diagram of another embodiment of a nano RFID device constructed according to principles of the invention;

FIG. 3 is a block diagram of another embodiment of a nano RFID device constructed according to principles of the invention;

FIG. 4A is a block diagram of an embodiment of a nano RFID component constructed according to principles of the invention, along with part of a system for controlling the nano RFID component, also configured according to principles of the invention;

FIG. 4B is a block diagram of an embodiment of a nano RFID component constructed according to principles of the invention, along with part of a system for controlling the nano RFID component, also configured according to principles of the invention;

FIGS. 5A-5C are each a flow diagram of exemplary processes performed according to principles of the invention and using a nano RFID device constructed according to principles of the invention, such as the nano RFID devices shown in relation to FIGS. 1-4B; and

FIG. 6 is a flow diagram showing exemplary steps for using the nano RFID tag, constructed according to principles of the invention.

### DETAILED DESCRIPTION OF THE INVENTION

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. It also to be noted that as used herein and in the appended claims, the singular forms “a,” “an,” and “the” include the plural reference unless the context clearly dictates otherwise. Thus, for example, a reference to “an address” is a reference to one or more addresses and equivalents thereof known to those skilled in the art.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

In one aspect, the method and device of the invention may include providing a nano radio frequency identification (RFID) device (RFID tag) constructed to be about 150 nanometers or smaller in dimension that may be configured to deliver an effect (i.e., a toxin, a chemical compound, a virus, bacteria, or the like) on its target environment. In some aspects, the RFID device may include semiconductors as small as 90 nm, perhaps with some chips configured and provided at the 65 nm, 45 nm and/or 30 nm size level, in view of the current cutting edge state-of-the-art in nano-fabrication. In other aspects and/or versions, the size of the RFID device may be constructed in size of about 200 nanometers in any dimension (width, height and length).

The technology for the included electrical circuitry may include CMOS or related technology for low power consumption. A nano RFID device constructed by nanotechnology techniques described herein may provide advantages over the currently available RFID devices such as permitting the RFID device to be distributed by airborne, ingestion, or contact distribution (perhaps by aerosol or a mist, for example), and/or constructed to react to a specific environmental factor for embedded/affixing to a surface or specific type of material (e.g., an organic material associated with a person or animal). This may provide for dynamic distribution of the RFID device to track targeted subjects or objects, and may provide for dynamically triggering releases of an effect based upon, among other possible factors, the identification information provided by the nano RFID device, for example.

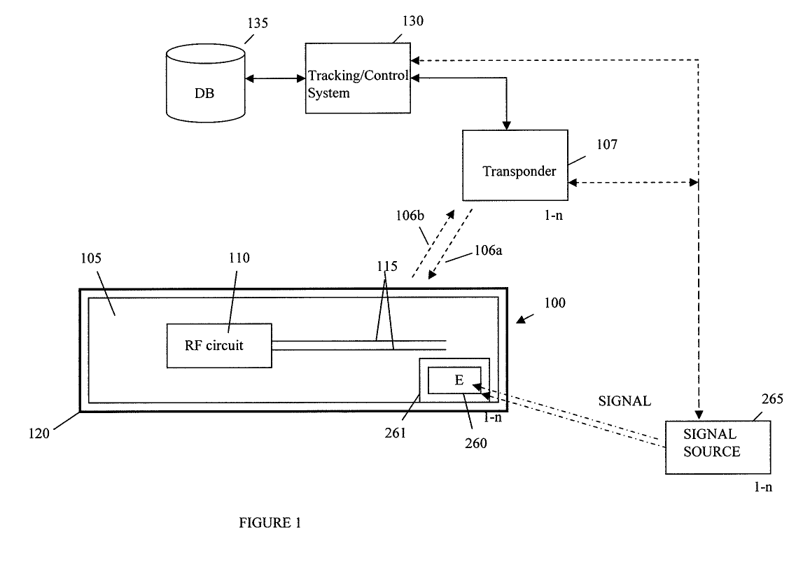

FIG. 1 is a block diagram of an embodiment of a passive nano RFID component, constructed according to principles of the invention, and an exemplary system configured according to principles of the invention, for controlling or tracking the nano RFID component, the passive nano RFID component generally denoted by reference numeral 100. The component 100 may include a nano RFID device 105 that may include a radio frequency (RF) circuit 110 that may be configured to respond to a received RF signal 106a, such as from transponder 107, and may be configured to provide identifying information of the nano RFID device 105 which may be associated with a composition, item, product, person, or similar object, when triggered by the received RF signal 106a. The identifying information may be electronically encoded alphanumeric data to uniquely or non-uniquely identify the nano RFID device 105. The RF circuit 110 may also be configured with a memory (not shown), such as EEROM or EEPROM, for example, to store other information that may be transmitted along with the identifying information.

The nano RFID device 105 may also include an antenna 115 that may receive an RF signal 106a and also emit a response signal 106b as generated by the RF circuit 110. The antenna 115 may be at least one carbon nano tube or other nano material suitable for RF reception and emission such as for transmitting a backscatter signal, such as signal 106b. Also shown as part of the general nano RFID component 100 is a layer 120, such as a plastic coating or other suitable composition that provides environmental protection for the nano RFID device 105, and/or provides an adhering or attaching property as discussed more fully below. The nano RFID device 105 may have a size of about 150 nm, or smaller, in any dimensions (length, width and thickness). In other aspects, the RFID device 105 may have a size of about 200 nm, or smaller in any dimension (length, width or thickness).

The nano RFID device 105 also may be constructed with an effect 260 that may include any of: an organic compound, an inorganic compound, a virus, bacteria, a toxin, a chemical, a radioactive tag, and the like, or combinations thereof. For example, the effect 260 may comprise a neurotoxin. In some embodiments, the effect 260 may be encased within a encasement 261 for encasing the effect 260 such that the encasement 261 may be responsive to a specific trigger such as, for example, a specific radio frequency, perhaps in the microwave range, emitted by a signal source 265, which may rupture the encasement 261 causing the effect 260 to be released within or on a target. Other encasements may be employed that may be ruptureable by other similar techniques, such as dissolving techniques, for example. In one aspect, the layer 120 may be configured to serve as the ruptureable layer (perhaps responsive to a signal from signal source 265), obviating the need for the encasement 261. In some aspects, the signal source 265 and transponder 107 may be the same unit providing the aforementioned functions.

Also shown in FIG. 1, is a system for controlling and interacting with the nano RFID component 100 and related devices. The transponder 107, which may be one of a plurality of transponders (1-n), may transmit a signal 106a to the nano RFID component 100 to prompt for a response 106b for indentifying information associated with the nano RFID component 100. The transponder 107 may be in communication with a tracking/control system 130 for conveying or receiving information, managing, tracking, or operationally rendering commands to one or more nano RFID components (1-n) 100, perhaps substantially in real-time. The tracking/control system 130 may be operatively connected to a database 135 that maintains operational information concerning the identities of the plurality of nano RFID components (1-n) 100 and any operational parameters for controlling the conditional action or level of operational response related to the plurality of nano RFID components (1-n) 100, explained more fully below.

The tracking/control system 130 may also be in operational communication with a signal source 265 for dynamically controlling a signal to cause activation of the effect 260, such as rupturing the encasement 261, for example. The tracking/control system 130 may be configured to identify a particular nano RFID component 100 by way of the response signal 106b by matching the identity of the nano RFID component 100 with information in the database 135, for example. Based on a match, a command may be given to the signal source 265 to generate a signal to cause the activation or dispensing of the effect 260.

Moreover, the signal may be specifically selected and matched to the construction parameters (perhaps also maintained in database 135) used in a particular nano RFID component 100 to cause activation of the effect in a specific nano RFID component or components (more than one component may have the same construction parameters). This may include matching/setting the signal type and characteristics emitted by signal source 265 to parametric characteristics of the encasement 261 to cause a rupture, for example. This matching may include selecting a particular frequency of the signal at a particular power level, for instance. The matching may also include other selection factors such as a pulse rate of the signal. This matching process may permit selectivity for activating one effect 260 associated with one nano RFID component over another nano RFID component (or subsets of components) having different parametric characteristics for the encasement 261.

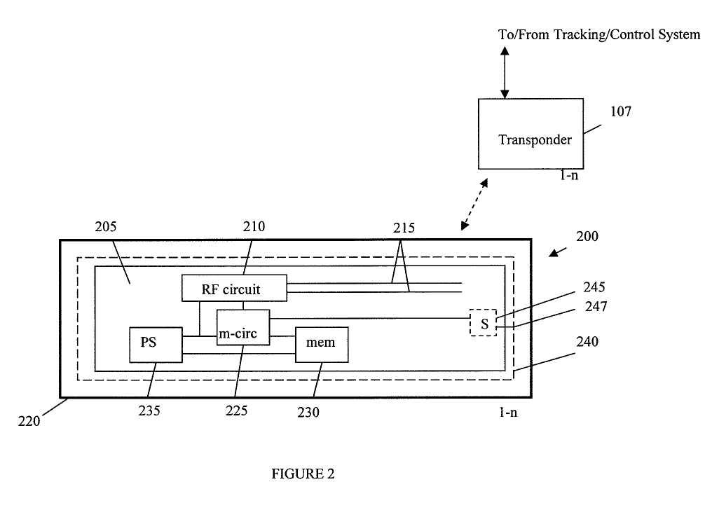

FIG. 2 is a block diagram of an embodiment of an active nano RFID component, generally denoted by reference numeral 200. The nano RFID component 200 may include an active nano RFID device 205 and may include a RF circuit 210 that is configured to receive a RF signal (such as from transponder 107) and configured to emit data in response, as initiated by the RF circuit 210 or as initiated by a micro-circuit 225 (which may comprise a micro-processor, or the like) that provides additional processing and control capability. The emitted data may include identifying information of the active nano RFID device 205, which may be associated with a composition, item, product, person, or similar entity. The identifying information may be electronically encoded alphanumeric data, perhaps encrypted, to uniquely identify the nano RFID device 205. The active nano device 205 may also be configured with a memory 230, such as EEROM or EEPROM, for example, to store the identifying data, and/or other information that may be transmitted along with the identifying information.

The active nano device 205 may also include a nano power source 235 such as a nano battery, for example. The power source 235 may be fabricated as a nano chemical-battery or nano bio-battery, as is known in the art. The power source 235 may be configured to provide power to the RF circuit 210, micro-circuit 225 and/or memory 230. The power source 235 may provide sufficient power to cause a stronger response signal, hence greater transmission distances, as compared with a passive nano RFID device, such as shown in relation to FIG. 1, for example. An antenna 215 may receive an RF signal and also emit a response signal (both signals are shown as a bidirectional signal for simplicity) as generated by the RF circuit 210 that may be initiated by the micro-circuit 225. The antenna 215 may be at least one carbon nano tube or other nano material suitable for RF reception and emission such as transmitting the outbound signal. Also, the nano RFID component 200 may involve a layer 220, such as a plastic coating or other suitable composition that provides environmental protection for the nano RFID device 205 and/or provides suitable adhering properties for attaching or implanting the nano RFID component 200 to a subject, as described more below. The RF circuit 210 and the micro-circuit 225 may be combined in some embodiments. The nano device 205 may have a size of about 150 nanometers, or smaller, in each dimension (length, width and thickness).

The nano RFID component 200 may also be constructed with an effect layer 240 that may be ruptureable (i.e., able to be ruptured) by a trigger 247. The micro-circuit 225 may receive a command from a transponder 107 to cause the switch 245 to activate trigger 247 causing a rupture of the effect layer 240, imparting a resulting effect on a target subject or object. The effect layer 240 may comprise any of: an organic compound, an inorganic compound, a virus, bacteria, a toxin, a chemical, a radioactive tag, and the like, or combinations thereof. For example, the effect layer 240 may comprise, at least in part, a neurotoxin.

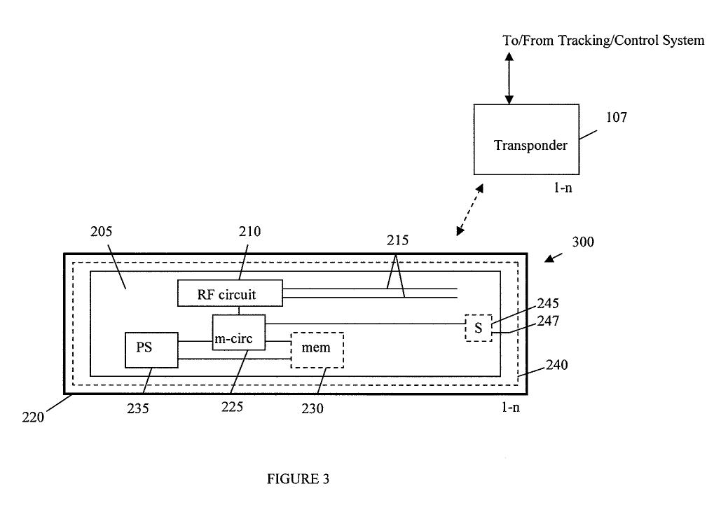

FIG. 3 is a block diagram of an embodiment of a semi-passive nano RFID component, generally denoted by reference numeral 300. The embodiment of FIG. 3 may be configured similarly to the device shown in FIG. 2, except that the nano power source 235 does not power the response signal, rather the response signal may be provided in the same manner as a passive nano RFID device (such as shown in FIG. 1, for example) by backscatter techniques. However, in some embodiments, the RF circuit 210 may be powered at least in part by the nano power source 235 for interacting with the micro-circuit 225 for exchange of information (perhaps as contained in memory 230), such as identification data, and so that the exchanged information may be transmitted (or received by micro-circuit 225), as appropriate. The nano RFID component 300 excluding protective layer 220 may have a size of about 150 nm, or smaller, in all dimensions (length, width and thickness). The operative features such as the ruptureable effect layer 240 may operate the same as described previously in relation to FIG. 2.

In certain aspects, the nano RFID component of FIGS. 1-4B may be constructed having a layer 120, 220 that facilitates affixing the nano RFID component (e.g., 100, 200, 300, 270, 271) to a subject or target. The layer 120, 220 at least surrounds the circuitry (e.g., RF section), preferably it surrounds both the circuitry and the antenna, as shown, but is not a limiting requirement. (Moreover, the layer 120, 220 may be optional, depending on intended application). In use, a plurality of nano RFID components 100, 200, 300, 270, 271 may be configured with identical indicia and distributed by broadcasting to a selected target or targets. The broadcasting may be accomplished by airborne distribution (e.g., for inhalation by one or more targets), contact distribution including injection/insertion, ingestion distribution (e.g., by drinking or eating), or the like. Any combination of nano RFID components 100, 200, 300, 270, 271 may be employed when broadcasting or delivering to a target(s).

By way of an example, the layer 120, 220 may include nano claws (e.g., analogous to the functional properties of Velcro®) that may adhere to clothing, hair, skin, and the like. Another example of layer 120, 220 may include an inorganic or organic type of adhesive (e.g., a bioglue, a biological adhesive, or the like) that bonds the nano RFID component 100, 200, 300, 270, 271 to a subject (human, animal or possibly an inanimate object). In some applications, the layer 120, 220 may activate adherence properties upon contact with, or in the presence of, human or animal organic properties such as skin oils, body fluids, body excretions (e.g., perspiration, saliva, or the like), body proteins (e.g., hair, skin, blood, or the like). Generally, when the layer 120, 220 is constructed to respond in some way to immediate environmental characteristics, the layer may be generally referred to as an environmentally reactive layer.

In some aspects, the layer 120, 220 may be pre-constructed so that the adhering properties may be for a limited time period (e.g., 6 months, one year, two years, or the like) and may be constructed to later become inoperative and release (i.e., lose its adhering properties). When the adhering properties become inoperative and release, the nano RFID component 100, 200, 300, 270, 271 may be eventually excreted by the target subject.

In other aspects, the layer 120, 220 (and also the effect 260) may be constructed so that after a pre-determined extended time period (e.g., one year, two years, three years, or the like), perhaps in the extended presence of body fluids, the effect layer 240 (and effect 260) may become innocuous. In this way, a nano RFID component 100, 200, 300, 270, 271 may be allowed to become innocuous over time and its capacity to impart an effect may become disabled. However, prior to the predetermined time period, the nano RFID may deliver the effect upon receipt of an activation signal.

In other applications, the layer 120, 220 may also be constructed to be activated when the layer is in contact with a surface or material at a specific temperature range such as at human body temperature, for example, perhaps within a range of a pre-determined amount of degrees. In this way, a higher degree of adhering success may be achieved when targeting the nano RFID component to a subject.

For still other applications, the layer 120, 220 may be constructed with an adhering property that is responsive to internal body conditions such as the lungs, for instance. For example, if a subject were to inhale one or more of the distributed (perhaps by way of airborne aerosol or mist) nano RFID components (100, 200, 300, 270, 271), the layer 120, 220 may be activated in the presence of specific enzymes or hormones (or other compounds) present in the lungs. Alternatively, or in addition, the layer 120, 220 may also be constructed to respond to a moisture range and/or a temperature range such as that found in lungs, causing adherence. By way of another example, a RFID component 100, 200, 300, 270, 271 may be constructed such that when the nano RFID component 100, 200, 300, 270, 271 is ingested, stomach acids, intestinal bacteria, or intestinal fluids may activate the layer 120, 220 to initiate adherence.

Moreover, the nano RFID device 105, 205 may be dynamically activated from a “dead” state for responding to a RFID query. That is, the nano RFID device 105, 205 may be inhibited initially when configured so that it appears to be a “dead” device, but in the presence of specific environmental triggers (e.g., the lungs, stomach, proteins, fluids, compounds, temperatures, or similar environmental triggers) the device 105, 205 may change its internal state and become “active” and begin responding (e.g., providing internal identification data) to external RFID triggers (e.g., when an external signal from a transponder 107 may be detected by the nano RFID device). This “dead” and subsequent “active” capability may prevent or reduce inadvertent detection of the nano RFID device until successfully implanted into or affixed to a target, as described previously. In some aspects, this “awakening” stimulus of a “dead” nano RFID device 105, 205 may be associated with or dependent upon the activation of layer 120, 220, as described previously. That is, when layer 120, 220 is activated by a specific environmental condition, the nano RFID device 105, 205 may also be dynamically activated and configured to respond to any subsequently detected external RFID trigger, which may include responding to a signal for release of the effect 260.

In some aspects, the layer 120, 220 may also be constructed with magnetic or electrostatic properties for adhering to specific types of materials, or in specific environmental conditions. The layer 120, 220 may also be constructed with more than one type of adhering properties as described herein.

Alternatively, the active nano device described herein may be constructed to provide a response message without a need of an external trigger so that the active nano device may transmit identifying information continuously or periodically, perhaps based on a pre-determined interval.

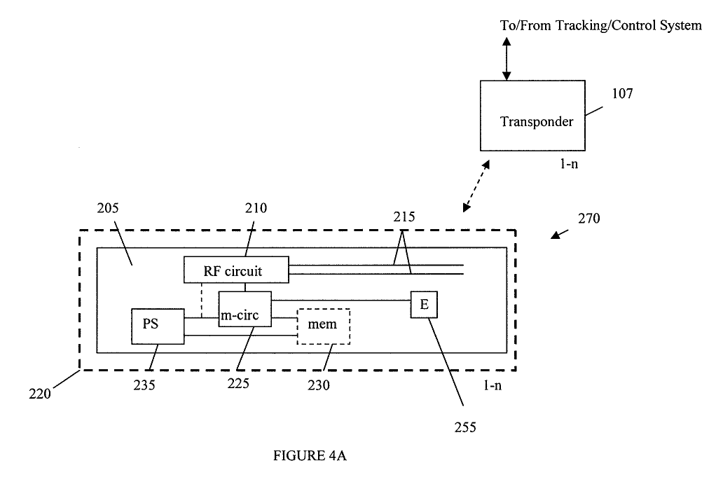

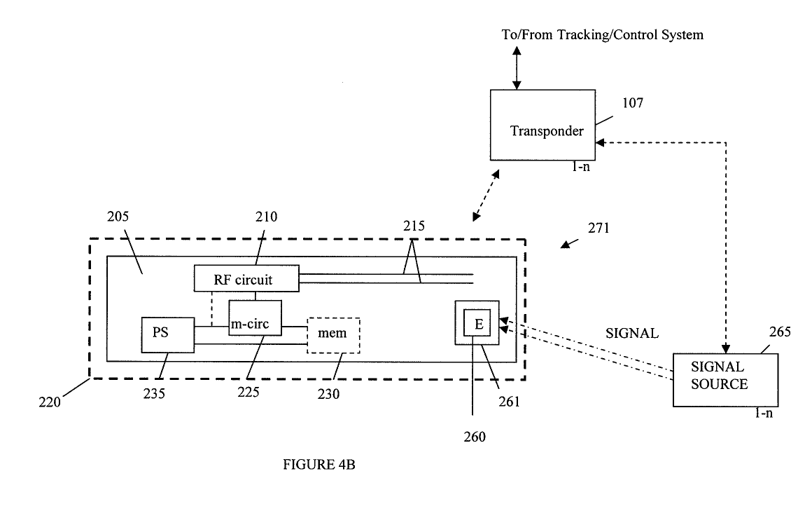

FIG. 4A is a block diagram of an embodiment of a nano RFID component constructed according to principles of the invention, along with part of a system for controlling the nano RFID component, also configured according to principles of the invention. The nano RFID component 270 is constructed similarly to the nano RFID component of FIG. 2, except that the effect 255 may be operationally controlled by the micro-circuit 225 via a message from an external system. The embodiment of FIG. 4A also shows an optional protective layer 220, which may be an environmentally reactive layer. An effect layer (e.g., layer 240 of FIG. 2) may not be present in the embodiment of FIG. 4A. The RF circuit 210 may or may not be powered by the power source 235.

FIG. 4B is a block diagram of an embodiment of a nano RFID component constructed according to principles of the invention, along with part of a system for controlling the nano RFID component, also configured according to principles of the invention. The embodiment of FIG. 4B is similar to the embodiment of FIG. 4A except that the nano RFID component 271 includes an effect 260 and is shown encased by encasement 261, and is not operatively connected to the micro-circuit 225. The effect 260 may be activated by rupturing the encasement by an external signal produced by signal source 265, for example.

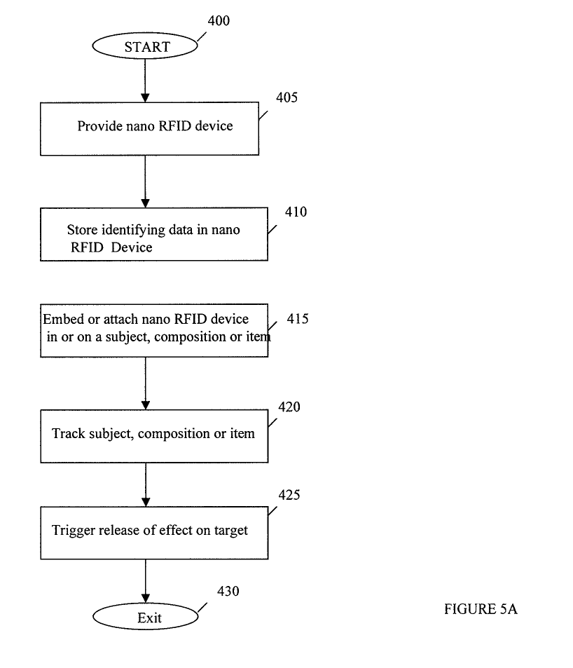

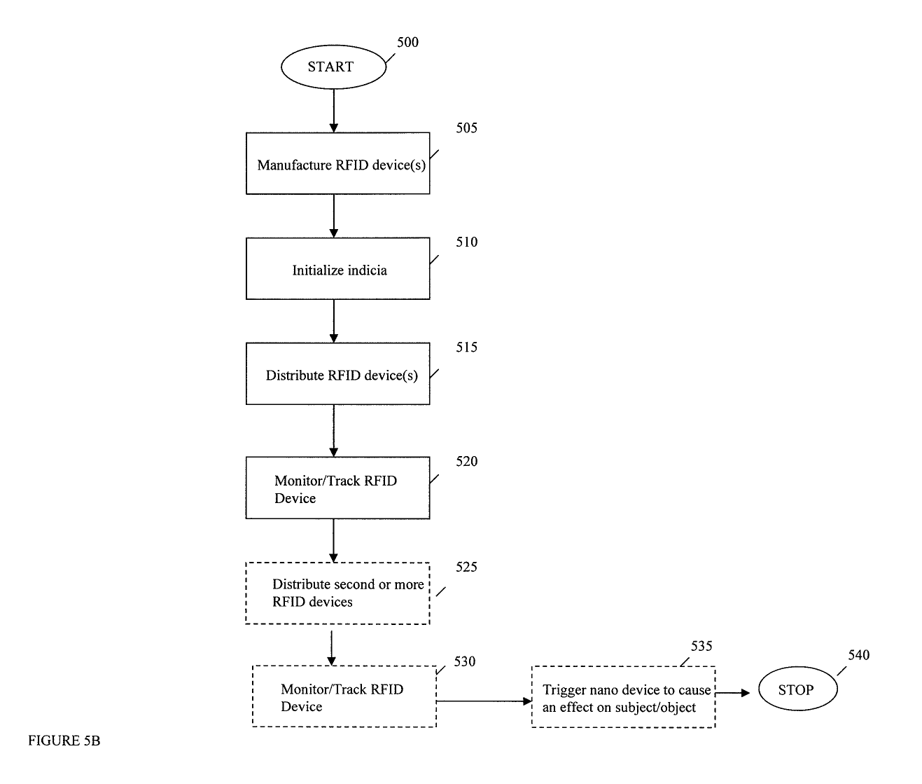

FIG. 5A is a flow diagram of steps for using an embodiment of a nano RFID device, according to principles of the invention, starting at step 400. FIG. 5A (and all other flow diagrams herein) may also represent a block diagram of the components for performing the steps thereof. The components may be software components executing on a suitable computing platform, hardware components, or combination of hardware and software. Moreover, the components may be stored in a suitable storage medium such as RAM, ROM, a hard drive, a CD, a DVD, and the like, that when executed by a processor performs the corresponding step.

At step 405, a nano RFID device (i.e., nano RFID tag) may be provided, such as any of the nano RFID components shown in relation to FIGS. 1, 2, 3, 4A and 4B. At step 410, one or more nano RFID components may be initialized with identifying data which may or may not be unique to each other, or to other nano RFID components.

At step 415, the nano RFID components may be embedded into a subject, composition or material, item, or product, or distributed to affix to a subject, such as by contact, injection, ingestion, inhalation, or the like. At step 420, the subject, composition, material, product or similar object may be tracked by RFID techniques and the resulting identification information received by RFID exchange between the RFID device(s) and transponder(s) for possessing according to an application or system (such as the tracking/control system 130). The processing may include correlating a date and time of distribution of the RFID component(s), as may be previously recorded, to determine identification of a target and/or track a probable movement of the subject, object, item, material and to be used in a tracking analysis, perhaps providing an identification or general categorization by time and place circumstances. At step 425, based on the tracking analysis and/or identification information, a signal (perhaps encrypted) may be sent to the nano RFID device(s) (which may decrypt the encrypted message, if needed) to trigger release of the effect. The effect may comprise, for example, any of: an organic compound, an inorganic compound, a virus, bacteria, a toxin, a chemical, a radioactive tag, or the like, or combinations thereof. At step 430, the process ends.

In some applications, the identification information within a nano RFID component 100, 200, 300, 271, 270 may be duplicated among more than one nano RFID device (perhaps thousands, millions, or even more), so that more than one nano RFID device 100, 200, 300, 270, 271 may have the same identification information, or at least a subset of the same information. This may be useful when distribution of the nano RFID device is to be accomplished by way of a broadcast methodology, for example, and multiple nano RFID devices may be needed with identical information to assure that at least one reaches a target or set of targets that may be located within a target zone. Combinations of the various types (e.g., active and passive) of nano RFID components may be employed.

FIG. 5B is a flow diagram showing exemplary steps for using the nano RFID tag, constructed according to principles of the invention, starting at step 500. At step 505, one or more nano RFID tags may be constructed according to principles of the invention, such as described in relation to FIGS. 1, 2, 3, 4A and 4B. The nano RFID tags may be constructed with any suitable layer 120, 220, as described previously, depending on application, including an environmental reactive layer. In some applications, layer 120, 220 may not be needed and may be omitted. At step 510, the one or more nano RFID tags may be initialized with identifying indicia suitable for an application and might include any of: a serial number, a name, a date, a time, a location (e.g., country or GPS coordinate), and the like. The one or more nano RFID tags may be uniquely identified, or may have a common set of indicia.

At step 515, the initialized one or more nano RFID tags may be distributed, broadcasted or delivered to one or more targets (e.g., human, animal, or inanimate object). The delivery may be accomplished in nearly any suitable manner, including direct contact with or insertion into the target, or indirect delivery through a channel such as a food channel, water channel, or airborne channel and the like. At step 520, a system of tracking the nano RFID tags may be deployed suitable for the application. This may include deploying one or more RFID transponders for triggering the nano RFID devices to respond with internal information for identifying the nano RFID, and hence the person, animal, object, or the like, associated with the nano RFID. The RFID transponder(s) may be deployed at nearly any location including, for example, private or public transit points such as a home, a place of business or gatherings, airports, ships, planes, ports of entry, car rental locations, train depots, buildings, trails, and the like. Virtually any location may be provided or equipped with a RFID transponder for detecting and reading a RFID tag.

At optional step 525, a second distribution of RFID tags may be performed, perhaps having different indicia from the first set of RFID tags as distributed at step 515. In this manner, a subset of targets from the distribution activity of step 515 may be retagged or additionally tagged, so that a subset of the initially tagged targets may be tracked. This may be beneficial for statistically monitoring movement of sets of targets or to identify a selected subset's movement over time. Other subsets of targets may be tagged as necessary. At optional step 530, the second distribution of tags may be tracked or monitored.

At optional step 535, based on tracking information provided to transponders, a signal may be sent to the nano RFID components to release an effect. The command to transmit the signal may be initiated by a tracking system (such as system 130, for example). The signal may be generated by a transponder by an encoded message, for example, or may be transmitted by a separate device. This signal may be an encoded message (perhaps encrypted) that is decodable by the nano RFID device. Alternatively, the signal may be a predetermined signal such as a particular frequency tuned (and/or pulsed perhaps) for the particular nano RFID component having particular conduction parameters to cause a rupture (for example) to release an effect. The frequency could be any effective frequency that causes a release of the effect such as a microwave frequency, for example. In some applications, the signal may be a magnetic based signal. The effect may comprise, for example, any of: an organic compound, an inorganic compound, a virus, bacteria, a toxin, a chemical, a radioactive tag, or the like, or combinations thereof. At step 540, the process ends.

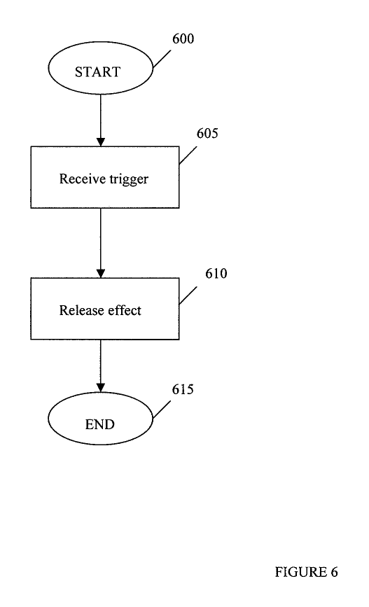

FIG. 6 is a flow diagram of exemplary steps performed according to principles of the invention, starting at step 600. At step 605, a trigger signal may be received at a nano RFID device constructed according to principles of the invention. The signal may be an encoded signal, perhaps encrypted, and may be decrypted by the nano RFID device. Alternatively, the signal may be a signal such as an RF or microwave frequency (or other effective frequency range) tuned to a specific frequency or frequency range, perhaps modulated according to a pre-determined protocol, which causes a response in the nano RFID component to unleash the effect. Alternatively, the signal may be an applied magnetic field. At step 610, based on the signal received, the effect may be dispersed in or on the target subject or object. The effect may comprise a compound, a chemical, a virus, a toxin, an element, bacteria, or the like. At step 615, the process ends.

The nano RFID components constructed and applied in usage according to the principles herein may be used to track and deliver an effect on people, particularly terrorists, animals and/or objects. The effect may cause a temporary result, a longer term result, an intermittent result, or a terminal/permanent result.

Relevant technology providing a general overview or background for various techniques and principles discussed or referred to herein may be found in several publications such as, for example: “Nanophysics and Nanotechnology: An Introduction to Modern Concepts in Nanoscience,” Edward L. Wolf, Wiley-VCH; 2 edition (Oct. 20, 2006); “Springer Handbook of Nanotechnology,” Springer, 2nd rev. and extended ed. edition (Mar. 27, 2007); “Introduction to Nanoscale Science and Technology (Nanostructure Science and Technology),” Springer, 1^{st} edition (Jun. 30, 2004); “Fundamentals of Microfabrication: The Science of Miniaturization,” Marc J. Madou, CRC, 2 edition (Mar. 13, 2002); “RFID Essentials (Theory in Practice),” O'Reilly Media, Inc. (Jan. 19, 2006); and “RFID Applied” by Jerry Banks, David Hanny, Manuel A. Pachano, Les G. Thompson, Wiley (Mar. 30, 2007); “Carbon Nanotubes: Properties and Applications” by Michael J. O'Connell, CRC (May 2006); “Nanoscale Science and Technology” by Robert Kelsall, Ian Hamley, Mark Geoghegan, Wiley (April 2005); and “Bioadhesive Drug Delivery Systems,” by Edith Mathiowitz, Donald Chickering III, Claus-Michael Lehr, all of which are hereby incorporated by reference in their entirety herein.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention. Moreover, any document, publication or patent referred to herein is incorporated by reference in its entirety.

What is claimed is:

1. A nano radio frequency identification (RFID) apparatus, comprising:
a radio frequency (RF) section configured to be responsive to an RF signal;
an antenna operatively coupled to the RF section to receive the RF signal and to emit an identification response; and
an effect component contained within the nano RFID apparatus configured to impart an effect, the effect component constructed to release the effect based upon receipt of a release signal,
wherein the nano RFID device is configured to be less than about 150 nanometers in width, length and thickness.

2. The nano RFID apparatus of claim 1, further comprising a layer enveloping at least the RF section.

3. The nano RFID apparatus of claim 2, wherein the layer comprises a protective covering to protect the nano RFID device.

4. The nano RFID apparatus of claim 2, wherein the layer comprises an environmentally reactive layer.

5. The nano RFID apparatus of claim 2, wherein the layer is constructed to facilitate attaching to, or embedding in, a target.

6. The nano RFID apparatus of claim 1, wherein the RFID apparatus is constructed to be distributable by airborne delivery and inhalable by at least one target.

7. The nano RFID apparatus of claim 1, wherein the RF section is configured to be responsive by backscattering a received signal.

8. The nano RFID apparatus of claim 1, wherein the RF section is configured to be responsive with data identifying the nano RFID device.

9. The nano RFID apparatus of claim 1, wherein the nano RFID apparatus is configured to provide tracking information.

10. The nano RFID apparatus of claim 1, wherein the nano RFID apparatus comprises a passive RFID device.

11. The nano RFID apparatus of claim 1, wherein the antenna comprises at least one nano carbon tube.

12. The nano RFID apparatus of claim 1, wherein the nano RFID apparatus is an RFID tag.

13. The nano RFID apparatus of claim 1, further comprising a micro-circuit to process the received signal.

14. The nano RFID apparatus of claim 13, further comprising a memory operatively coupled to the micro-circuit to store identification data.

15. The nano RFID apparatus of claim 1, further comprising a nano power source.

16. The nano RFID apparatus of claim 15, wherein the power source is a nano bio-battery.

17. The nano RFID apparatus of claim 15, wherein the nano power source powers the RF section for emitting the response.

18. The nano RFID apparatus of claim 17, wherein the nano power source powers the RF section at least in part and the emitted response is emitted by backscatter.

19. The nano RFID apparatus of claim 1, wherein the nano RFID apparatus is constructed to be dynamically responsive or non-responsive to an RF signal.

20. The nano RFID apparatus of claim 2, wherein the RF section is constructed to be dynamically responsive or non-responsive to an RF signal based on a state of the layer.

21. The nano RFID apparatus of claim 1, wherein the effect component is configured to impart an effect comprising any of: an organic compound, an inorganic compound, a virus, bacteria, a toxin, a chemical, a radioactive tag, or combinations thereof.

22. The nano RFID apparatus of claim 21, wherein the toxin is a neurotoxin.

23. The nano RFID apparatus of claim 1, wherein the effect component is constructed to release the effect based upon receipt of an encoded signal.

24. The nano RFID device of claim 1, wherein the effect component is operatively coupled to the RF section.

25. The nano RFID apparatus of claim 2, wherein the layer is constructed to adhere to a target based on a characteristic of the target.

26. The nano RFID apparatus of claim 2, wherein the layer comprises an effect responsive to a signal.

27. The nano RFID apparatus of claim 2, wherein the layer becomes inoperable at a predetermined time.

28. The nano RFID apparatus of claim 1, wherein the effect component is constructed to become inoperable based on exceeding predetermined time period.

29. A method for using a nano radio frequency identification (RFID) device, the nano RFID device comprising:
a radio frequency (RF) section configured to be responsive to an RF signal;
an antenna operatively coupled to the RF section to receive the RF signal and to emit an identification response; and
an effect component contained in the nano RFID device to release an effect based upon a release signal;
wherein the nano RFID device is configured to be less than about 150 nanometers in width, length and thickness, the method comprising the steps of:
storing identification data within the nano RFID device;
distributing the nano RFID device to a target for association with the target;
tracking the nano RFID device by using the emitted identification response; and
transmitting a signal to release the effect based on the identification response.

30. The method of claim 29, wherein the RFID device is configured to adhere to a human or animal target.

31. The method of claim 29, wherein the step of distributing includes airborne distributing of the nano RFID device.

32. The method of claim 29, wherein the step of distributing includes contact distribution of the nano RFID device.

33. The method of claim 29, wherein the emitted response includes the identification data.

34. The method of claim 29, further comprising the step of adhering the nano RFID device to the target.

35. The method of claim 34, wherein the step of adhering is achieved by an environmentally reactive layer of the nano RFID device.

36. The method of claim 34, wherein the step of adhering includes a biological adhesive.

37. The method of claim 34, wherein the step of adhering includes one of a magnetic adherence technique and an electrostatic adherence technique.

38. The method of claim 29, wherein the step of distribution causes the association with the target by ingestion.

39. The method of claim 29, wherein the step of distribution causes the association with the target by way of inhalation.

40. The method of claim 29, wherein the step of distribution causes the association with the target by way of insertion into the target.

41. The method of claim 29, wherein the nano RFID device further comprises a layer surrounding at least the radio frequency (RF) section.

42. The method of claim 41, wherein the layer comprises at least any one of: an environmentally reactive layer, a magnetically enabled layer, an electrostatically enabled layer, and a mechanically configured layer to cause adherence.

43. The method of claim 41, wherein the layer comprises a protective layer.

44. The method of claim 29, wherein the step of transmitting a signal to release the effect releases any one of: an organic compound, an inorganic compound, a virus, bacteria, a toxin, a chemical, a radioactive tag, or combinations thereof.

45. A method of delivering an effect on a target, the method comprising the steps of:
distributing a nano radio frequency identification (RFID) tag that has an effect component to a target; and
releasing the effect component at the target.

46. The method of claim 45, wherein the nano RFID tag is configured to be less than about 150 nanometers in width, length and thickness.

47. The method of claim 45, wherein the step of releasing is based upon a received signal.

48. The method of claim 45, wherein the step of distributing includes distributing by any one of: an airborne distribution technique, a contact distribution technique, and an ingestion distribution technique.

49. The method of claim 45, wherein the step of releasing an effect component includes releasing any one of: an organic compound, an inorganic compound, a virus, bacteria, a toxin, an element, a radioactive tag, or combinations thereof.

50. The method of claim 45, further comprising tracking the distributed nano RFID tag and executing the releasing step based upon information gathered by the tracking.

51. A nano radio frequency identification (RFID) apparatus, comprising:
an effect component contained within the nano RFID apparatus configured to impart an effect, the effect component constructed to release the effect based upon receipt of a release signal,
wherein the nano RFID apparatus is configured to be less than about 200 nanometers in width, length and thickness.

52. The nano RFID apparatus of claim 51, wherein the effect component comprises any one of: an organic compound, an inorganic compound, a virus, bacteria, a toxin, an element, a radioactive tag, or combinations thereof.
